(19) United States
(12) Patent Application Publication
(10) Pub. No.: US 2026/0263994 A1
(43) Pub. Date: Sep. 10, 2026

(54) EXHAUST GAS TREATMENT APPARATUS

(71) Applicant: NanoMist Technologies Co., Ltd., Naruto-shi, Tokushima (JP)

(72) Inventor: Kazuo MATSUURA, Naruto-shi (JP)

(21) Appl. No.: 18/873,743

(22) PCT Filed: Jun. 9, 2023
(86) PCT No.: PCT/JP2023/021563

§ 371 Date: Dec. 11, 2024

(30) Foreign Application Priority Data
Jun. 11, 2022 (JP) 2022-094765

(51) Int. Cl. B01D 53/18; B01D 53/50; B01D 53/56; B01D 53/78

(52) U.S. Cl. CPC B01D 53/18; B01D 53/50; B01D 53/56; B01D 53/78; B01D 2252/1035

(57) ABSTRACT

The exhaust gas treatment apparatus is provided with a steam generation unit that heats an absorbing solution to generate absorbing solution vapor, a mixing unit that mixes the vapor generated in the steam generation unit with exhaust gas, a cooling unit that cools and liquefies the absorbing solution vapor to absorb water-soluble gases in the exhaust gas, and a separation unit that separates the liquefied absorbing solution from the exhaust gas.

### CROSS-REFERENCE TO RELATED APPLICATIONS

This application is based upon and claims priority to Japanese Patent Application No. 2022-094765, filed on Jun. 11, 2022, the entire contents of which are incorporated herein by reference.

### BACKGROUND

The present invention relates to an exhaust gas treatment apparatus, and in particular to an optimal treatment apparatus for separating gases such as carbon dioxide, NOₓ, and SOₓ from exhaust gas discharged from an industrial plant such as an electricity generating facility, cement factory, or blast furnace; or for separating reusable gases such as ammonia, alcohol, ester, and toluene from exhaust gas discharged from various industrial plants.

Apparatus for removing carbon dioxide from exhaust gas have been developed (See JP2005-211878A and JP2018-79409.). These patent documents disclose technology wherein carbon dioxide is absorbed from exhaust gas by causing an absorbing solution that contains a carbon dioxide absorbing agent to make contact with the exhaust gas.

Prior art apparatus separate gases such as carbon dioxide contained in exhaust gas by contacting the exhaust gas with an absorbing solution.

However, efficient absorption of carbon dioxide into the absorbing solution is difficult by this methodology. To improve the efficiency of carbon dioxide absorption, it is necessary to increase the contact area between the absorbing solution and the carbon dioxide. This is typically achieved by a system that increases contact area by spraying absorbing solution as a mist and mixing it with the exhaust gas. Alternatively, contact area between the exhaust gas and the absorbing solution can be increased by spraying absorbing solution into a porous mat of fine fibers and passing exhaust gas through vacancies in the mat. However, even with these types of configurations, it is difficult to efficiently absorb gases such as carbon dioxide from the exhaust gas. As a result of the low separation efficiency, the treatment apparatus becomes large, and separation cost is increased.

The present invention was developed to resolve the above drawbacks, and one objective of the invention is to provide an exhaust gas treatment apparatus that can efficiently separate water-soluble gases included in exhaust gas.

### SUMMARY OF THE INVENTION

One embodiment of the exhaust gas treatment apparatus of the present invention is provided with a steam generation unit that heats the absorbing solution to generate vapor, a mixing unit that mixes the vapor generated by the steam generation unit with the exhaust gas, a cooling unit that cools the absorbing solution vapor to absorb and liquefy water-soluble gases in the exhaust gas, and a separation unit that separates the liquefied absorbing solution from the exhaust gas.

The above exhaust gas treatment apparatus has the characteristic that it can efficiently separate water-soluble gases such as carbon dioxide contained in exhaust gas. This is because the treatment apparatus vaporizes absorbing solution in the steam generation unit, supplies absorbing solution vapor to the exhaust gas in the mixing unit, cools and liquefies the vapor in the cooling unit, and recovers the liquefied absorbing solution in the separation unit. When the absorbing solution is vaporized, each mole (18 g in the case of water) of absorbing solution generates 6×10²³ (Avogadro's constant) molecular size particles for dispersion into the exhaust gas. The vaporized absorbing solution disperses throughout the exhaust gas as micro-particles, which are much finer than un-vaporized mist particles, and mixes with water-soluble gases in the exhaust gas. When the absorbing solution vapor is cooled and liquefied in this state, water-soluble gases in the exhaust gas, such as carbon dioxide, are absorbed and liquefied.

Prior art apparatus increase contact area between liquid absorbing solution and exhaust gas by spraying the absorbing solution as mist into the exhaust gas. However, the average particle size of absorbing solution sprayed as mist is significantly greater than the particle size of vaporized absorbing solution, and efficient absorption is difficult. Although reducing absorbing solution mist particle size can increase contact area with the exhaust gas, a complicated apparatus is required to convert the absorbing solution into a fine mist and this increases equipment cost, energy consumption, and operating cost. In contrast, the exhaust gas treatment apparatus of the present invention vaporizes the absorbing solution to produce extremely small particle size on the order of angstroms, enabling the water-soluble gases to be absorbed and liquefied as the vapor is cooled. Accordingly, this realizes the characteristic that water-soluble gases such as carbon dioxide can be separated from exhaust gas in an extremely efficient manner.

In addition, the treatment apparatus of the present invention can not only separate carbon dioxide from exhaust gas, but can also separate all water-soluble gases that dissolve in the absorbing solution. By selecting an appropriate absorbing solution, specific water-soluble gases can be efficiently separated from the exhaust gas. For example, adjusting the pH of the absorbing solution to alkaline can efficiently separate gases such as carbon dioxide, while acidic absorbing solution can effectively separate NOₓ, SOₓ, ammonia gas, alcohols, esters, and toluene from exhaust gas.

In another embodiment of the exhaust gas treatment apparatus of the present invention, the steam generation unit can generate a steam mist that includes both absorbing solution vapor and mist, and that steam mist can be mixed with exhaust gas in the mixing unit.

In another embodiment of the exhaust gas treatment apparatus of the present invention, the steam generation unit can generate absorbing solution superheated steam.

In another embodiment of the exhaust gas treatment apparatus of the present invention, the steam generation unit can generate vapor from absorbing solution formed by dissolving a solute that chemically bonds with water-soluble gases in the exhaust gas.

The above-described exhaust gas treatment apparatus has the characteristic that the absorbing solution can efficiently absorb and separate water-soluble gases. It also has the characteristic that the amount of absorbing solution required for the targeted water-soluble gas can be reduced allowing efficient separation from the exhaust gas.

In another embodiment of the exhaust gas treatment apparatus of the present invention, the steam generation unit can generate vapor from absorbing solution that is water, seawater, alkaline solution, acidic solution, aqueous solution of calcium hydroxide, or aqueous solution of sodium hydroxide.

The above-described apparatus has the characteristic that specific gases can be efficiently separated by selecting absorbing solution such as water, seawater, alkaline solution, acidic solution, or aqueous solution of calcium hydroxide in which the gas readily dissolves.

In another embodiment of the exhaust gas treatment apparatus of the present invention, the steam generation unit can generate vapor from absorbing solution using waste heat from the industrial plant that emits the exhaust gas.

Since the above-described apparatus utilizes waste heat from an industrial plant that emits exhaust gas to vaporize the absorbing solution, exhaust gas can be treated while reducing operating cost.

In another embodiment of the exhaust gas treatment apparatus of the present invention, the exhaust gas is emitted from an electric power plant and the steam generation unit can use waste heat from the power plant to heat the absorbing solution.

Since the above-described apparatus utilizes waste heat from the electric power plant to vaporize the absorbing solution, it has the characteristic that exhaust gas can be efficiently treated while reducing energy consumed for vaporization and reducing operating cost.

In another embodiment of the exhaust gas treatment apparatus of present invention, the steam generation unit uses waste heat from a steam turbine that drives a generator in a power plant to heat and vaporize the absorbing solution.

Since the steam generation unit in this apparatus utilizes waste heat from the power plant steam turbine to heat and vaporize the absorbing solution, thermal energy required to cool the condenser with seawater can be reduced. Accordingly, this apparatus has the characteristic that carbon dioxide and other gases can be efficiently separated from exhaust gas using waste heat from the steam turbine while simultaneously controlling power plant seawater temperature rise.

In another embodiment of the exhaust gas treatment apparatus of present invention, exhaust gas emitted from a blast furnace is processed, and the steam generation unit can use waste heat from the blast furnace to heat and vaporize the absorbing solution.

Since this apparatus effectively utilizes waste heat from the blast furnace to generate absorbing solution vapor, it has the characteristic that water-soluble gases emitted from the blast furnace can be efficiently separated while improving energy efficiency and reducing operating cost.

In another embodiment of the exhaust gas treatment apparatus of present invention, exhaust gas emitted from a cement factory is processed, and the steam generation unit can use waste heat from a cement kiln to heat and vaporize the absorbing solution.

Since this apparatus effectively utilizes waste heat from a cement factory kiln to generate absorbing solution vapor, it has the characteristic that water-soluble gases emitted from the cement factory can be effectively separated while improving energy efficiency and reducing operating cost.

In another embodiment of the exhaust gas treatment apparatus of present invention, exhaust gas emitted from a chemical plant is processed, and the steam generation unit can use waste heat from the chemical plant to heat and vaporize the absorbing solution.

Since this apparatus effectively utilizes waste heat from a chemical plant to generate absorbing solution vapor, it has the characteristic that water-soluble gases emitted from the chemical plant can be effectively separated while improving energy efficiency and reducing operating cost.

In another embodiment of the exhaust gas treatment apparatus of present invention, the steam generation unit can heat and vaporize the absorbing solution using solar or geothermal heat.

In another embodiment of the exhaust gas treatment apparatus of present invention, the cooling unit can cool the vapor-containing exhaust gas, which is absorbing solution vapor mixed with exhaust gas, to cool the vaporized absorbing solution.

In another embodiment of the exhaust gas treatment apparatus of present invention, the temperature of the vapor-containing exhaust gas prior to cooling in the cooling unit can be greater than or equal to 50° C.

Since the above-described apparatus maintains the temperature of the vapor-containing exhaust gas at 50° C. or higher, it has the characteristic that the quantity of absorbing solution vapor supplied to the exhaust gas is increased allowing efficient separation of water-soluble gases from the exhaust gas.

In another embodiment of the exhaust gas treatment apparatus of present invention, the cooling temperature differential in the cooling unit can be made greater than or equal to 30° C.

In another embodiment of the exhaust gas treatment apparatus of present invention, the cooling unit can mix the absorbing solution vapor with exhaust gas to cool the absorbing solution vapor via the exhaust gas.

Since this apparatus uses exhaust gas to cool the absorbing solution vapor, it has the characteristic that cooling of the absorbing solution vapor can be realized with a simple structure.

In another embodiment of the exhaust gas treatment apparatus of present invention, a pre-treatment unit can cool the exhaust gas and separate a condensed solution, and the mixing unit can mix absorbing solution vapor with exhaust gas that has condensed solution removed.

In another embodiment of the exhaust gas treatment apparatus of present invention, the pre-treatment unit can cool the exhaust gas and separate condensed solution to separate NOₓ and SOₓ from the exhaust gas.

In another embodiment of the exhaust gas treatment apparatus of present invention, water-soluble gas separated by the apparatus can include carbon dioxide, NOₓ, SOₓ, ammonia gas, alcohols, esters, and toluene.

### BRIEF DESCRIPTION OF THE DRAWINGS

FIG. 1 is a block diagram of an exhaust gas treatment apparatus for one embodiment of the present invention.

FIG. 2 is a schematic diagram showing one example of the steam generation unit, mixing unit, and cooling unit.

FIG. 3 is a schematic diagram showing one example of the steam generation unit and mixing unit.

FIG. 4 is a schematic diagram showing another example of the steam generation unit and mixing unit.

FIG. 5 is a schematic diagram showing another example of the steam generation unit, mixing unit, and cooling unit.

FIG. 6 is a schematic diagram showing another example of the steam generation unit, mixing unit, and cooling unit.

FIG. 7 is a schematic diagram showing another example of the separation unit and cooling unit.

FIG. 8 is a schematic diagram showing yet another example of the separation unit and cooling unit.

### DETAILED DESCRIPTION

The following describes the present invention in detail with reference to the drawings. In the following descriptions, terms indicating specific directions and positions (such as “upper,” “lower,” and similar terms) are used as needed to facilitate understanding of the invention with reference to the drawings. However, use of these terms is not intended to limit the technical scope of the invention based on the meaning of those terms. Parts appearing in multiple figures with the same reference numbers indicate the same or equivalent parts or members. The embodiments described below are examples of the technical concept of the present invention and are not intended to limit the scope of the invention to those examples. Moreover, unless specifically stated otherwise, dimensions, materials, shapes, relative disposition, etc. of the components described below are merely illustrative. Additionally, what is described in one embodiment or example may also apply to other embodiments or examples. Further, the size and positional relationships of the components shown in the drawings may be exaggerated for the purpose of clear explanation.

### Embodiment

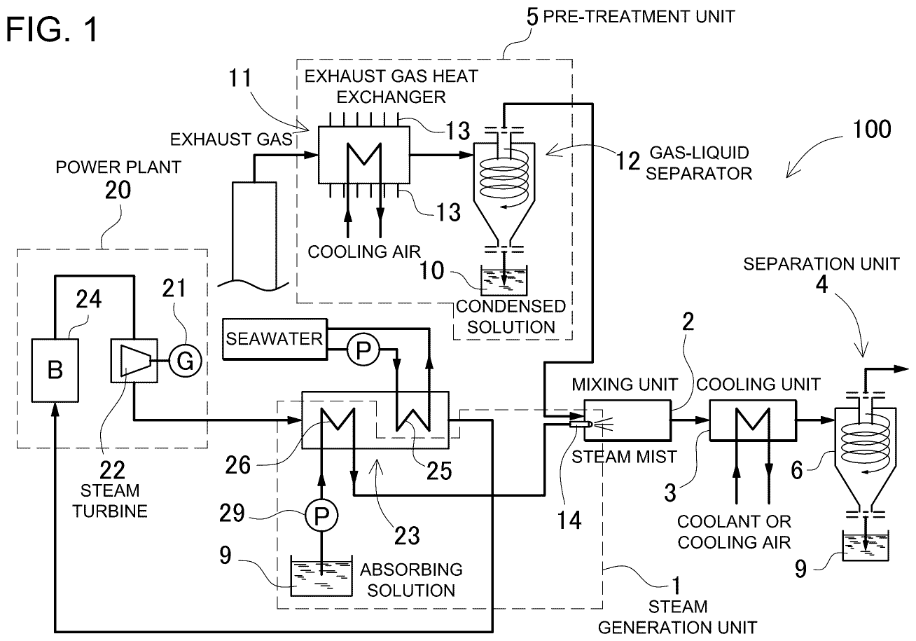

The block diagram in FIG. 1 shows an exhaust gas treatment apparatus 100 that separates water-soluble gases from exhaust gas. The apparatus 100 is provided with a steam generation unit 1 that heats the absorbing solution 9 to generate vapor, a mixing unit 2 that mixes the vapor produced by the steam generation unit 1 with exhaust gas, a cooling unit 3 that cools the vaporized absorbing solution to absorb and liquefy water-soluble gases in the exhaust gas, and a separation unit 4 that separates the liquefied absorbing solution 9 from the exhaust gas.

In addition, appropriate selection of the absorbing solution vaporized and supplied to the exhaust gas allows specific water-soluble gases to be efficiently separated. For example, a carbon dioxide separating exhaust treatment apparatus can mix alkaline absorbing solution vapor with exhaust gas to efficiently separate carbon dioxide, while acidic absorbing solution vapor enables efficient separation of NOₓ and SOₓ. Accordingly, the mixing unit is designed to mix vaporized absorbing solution in which the targeted water-soluble gas is highly soluble.

### Pre-Treatment Unit 5

The apparatus 100 shown in FIG. 1 is provided with a pre-treatment unit 5 that cools exhaust gas to separate a condensed solution 10. The apparatus 100 mixes absorbing solution vapor with exhaust gas from which condensed solution 10 has been separated in the pre-treatment unit 5. By separating condensed solution 10 from the exhaust gas, the pre-treatment unit 5 removes water-soluble gases dissolved in the condensed solution 10. Since the condensed solution 10 is made acidic by constituents of combustion exhaust gas, components such as NOₓ and SOₓ, which are highly soluble in acidic solution, are effectively dissolved in the condensed solution 10. Consequently, the pre-treatment unit 5 can separate NOₓ and SOₓ from exhaust gas by separating the condensed solution 10.

The pre-treatment unit 5 can separate NOₓ and SOₓ from exhaust gas with a simple structure. The exhaust gas includes fuel combustion solution in a vapor state at high temperature and nearly 100% relative humidity. The combustion solution in the exhaust gas is acidic and dissolves NOₓ and SOₓ. The pre-treatment unit 5 cools and separates combustion solution that contains dissolved NOₓ and SOₓ from the exhaust gas. The pre-treatment unit 5 is provided with an exhaust gas heat exchanger 11, which cools the exhaust gas to liquefy the combustion solution, and a gas-liquid separator 12, such as a cyclone separator, that separates the liquefied condensed solution 10 from the exhaust gas. Since this pre-treatment unit 5 can separate combustion solution and remove NOₓ and SOₓ from the exhaust gas, it has the characteristic that NOₓ and SOₓ can be separated from exhaust gas with simple hardware without adding absorbing solution vapor to the exhaust gas. As shown in FIG. 1, the exhaust gas heat exchanger 11 can be equipped with heat dissipation fins 13 on its outer surface for cooling with external air, or cooled air or refrigerant can circulate through the heat exchanger 11 to cool the exhaust gas.

Exhaust gas from which condensed solution 10 has been removed in the pre-treatment unit 5 has a reduced absolute humidity. This low humidity exhaust gas has little moisture content and can be mixed with large quantities of absorbing solution vapor in the subsequent mixing unit 2.

The apparatus 100 in FIG. 1 separates NOₓ and SOₓ from exhaust gas in the pre-treatment unit 5 and separates carbon dioxide in subsequent processing. However, the exhaust gas treatment apparatus of the present invention is not limited to separating specific water-soluble gases, nor does it necessarily require a pre-treatment unit. This is because water-soluble gases such as carbon dioxide, NOₓ and SOₓ, ammonia gas, alcohols, esters, and toluene can be separated from exhaust gas without a pre-treatment unit.

### Steam Generation Unit 1

The steam generation unit 1 can employ any mechanism capable of heating liquid absorbing solution 9 to produce vapor. Vapor generated by the steam generation unit 1 is mixed with exhaust gas to produce vapor-containing exhaust gas. Absorbing solution vaporized in the steam generation unit 1 can be a solution containing specific solutes that increase the solubility of water-soluble gases included in the exhaust gas. By appropriate selection of those solutes, the absorbing solution can target specific water-soluble gases for separation. For example, when water is used as the absorbing solution 9, 1 m³ of water at 15° C. can dissolve 1 m³ of carbon dioxide. Accordingly, to separate 1 m³ of carbon dioxide from exhaust gas, 1 m³ of water vapor needs to be added to the exhaust gas. Alkaline solution, in which carbon dioxide is ten times more soluble than in pure water, can be used to reduce the required amount of absorbing solution 9 by one-tenth. Alkaline and acidic absorbing solutions 9 can be optimized by adjusting their pH to target specific water-soluble gases.

Alkaline solutions are typically set to a pH of 8 or above, and preferably 8.5 or higher. Acidic solutions are typically set to a pH of 6 or below, and preferably 5.5 or lower.

Although water or seawater can be used as absorbing solution 9, specific solutes, which enhance the solubility of water-soluble gases contained in exhaust gas, can be dissolved in water to prepare absorbing solutions such as alkaline solution, acidic solution, aqueous solution of calcium hydroxide, or aqueous solution of sodium hydroxide. For example, solutes such as calcium hydroxide or sodium hydroxide can be dissolved in the absorbing solution 9 to make alkaline solution that efficiently absorbs carbon dioxide. The exhaust gas treatment apparatus 100 described above has the characteristic that specific solutes can be dissolved in the absorbing solution 9 to efficiently separate specific water-soluble gases from exhaust gas. Absorbing solutions that improve the solubility of the water-soluble gases targeted for separated include water, seawater, alkaline solution, acidic solution, and aqueous solution of calcium hydroxide.

The steam generation unit 1 converts absorbing solution 9 completely to vapor form, to a steam mist that contains both absorbing solution vapor and mist, or to superheated steam obtained by heating absorbing solution vapor to 100° C. or higher. Absorbing solution 9 is supplied to the mixing unit 2 in any of those states. Since a steam generation unit 1 that generates steam mist outputs both vapor and mist, it can supply a large quantity of absorbing solution 9 to the exhaust gas.

Steam mist, contains non-vaporized mist in addition to the vaporized steam resulting in a relative humidity that exceeds 100%. Steam mist can absorb water-soluble gases via both its vapor and mist components. While absorbing solution vapor absorbs and liquefies water-soluble gases with high efficiency, the mist also absorbs and aggregates those gases. Accordingly, when steam mist is mixed with exhaust gas, it effectively absorbs water-soluble gases with both its vapor and liquid components.

Exhaust gas that contains vapor and has a relative humidity of 100% or less can be cooled to a temperature below its dew point to condense and liquefy supersaturated absorbing solution vapor. The relative humidity of vapor-containing exhaust gas varies depending on the quantity of absorbing solution vapor (g) and temperature (° C.). To increase the quantity of supersaturated absorbing solution vapor, temperature of the vapor-containing exhaust gas in the subsequent separation process is preferably greater than or equal to 50° C. (saturated water vapor content=83 g/m³), more preferably greater than or equal to 60° C. (saturated water vapor content=130 g/m³), and optimally greater than or equal to 70° C. (saturated water vapor content=197 g/m³). The amount of absorbing solution vapor (saturated water vapor content) in the exhaust gas can be increased by increasing the temperatures vapor-containing exhaust gas. Vapor-containing exhaust gas that incorporates a high quantity of absorbing solution vapor, which is cooled to become supersaturated in the separation process, can increase the quantity of absorbing solution that has absorbed and liquefied water-soluble gases in the exhaust gas. Increasing the amount of the absorbing solution liquefied in the separation process improves the efficiency of water-soluble gas separation from the exhaust gas.

Since the steam generation unit 1 heats the liquid absorbing solution 9 to vaporization, thermal energy greater than the latent heat of vaporization is required. Since the latent heat of vaporization of water in the absorbing solution 9 is approximately 540 calories/g, a large amount of thermal energy is required for vaporization. The steam generation unit 1 shown in FIG. 1 utilizes waste heat from the industrial plant emitting the exhaust gas to supply the thermal energy necessary to vaporize the absorbing solution 9 thereby reducing energy cost. Since the amount of absorbing solution to be added to the exhaust gas increases in proportion to the volume of exhaust gas emitted by the plant, thermal energy required for vaporization also increases proportionally. However, the plant's waste heat also increases proportionally with the exhaust gas volume and the thermal energy required for vaporizing the absorbing solution 9 can be efficiently supplied using waste heat.

Industrial plants that emit exhaust gases waste a significant amount of thermal energy as unused heat. Unused thermal energy varies depending on the type of plant, and the amount and temperature distribution of unused heat is different for power plants (electricity generating facilities), steel mills (smelting furnaces), ceramic factories (cement or glass plants), etc. For example, waste heat temperature is 100-150° C. for power plants and is 100-200° C. for steel mills and ceramic factories. Since these temperature ranges are suitable for vaporizing absorbing solution, an apparatus that heats and vaporizes absorbing solution with unused waste heat from these types of industrial plants can effectively utilize the plant to vaporize the absorbing solution.

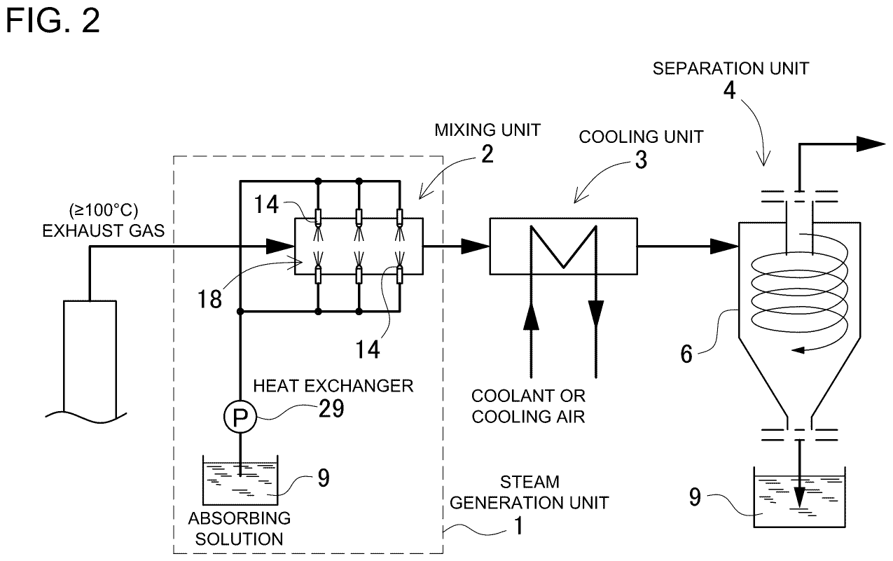

As shown in FIG. 2, the steam generation unit 1 can directly supply liquid absorbing solution 9 into the exhaust gas flow path 18 to vaporize the absorbing solution 9 using the thermal energy of the exhaust gas. This configuration enables efficient absorbing solution 9 vaporization by direct contact with the exhaust gas. Since this steam generation unit 1 can vaporize absorbing solution 9 by spraying it through nozzles 14 or otherwise dispersing it into the exhaust gas, system structure can be simplified. Namely, this steam generation unit 1, which supplies liquid absorbing solution 9 directly into the exhaust gas, achieves the characteristic that energy consumption for absorbing solution 9 vaporization can be reduced to lower operating cost, absorbing solution 9 vaporization structure can be simplified, and overall size reduction can reduce equipment cost.

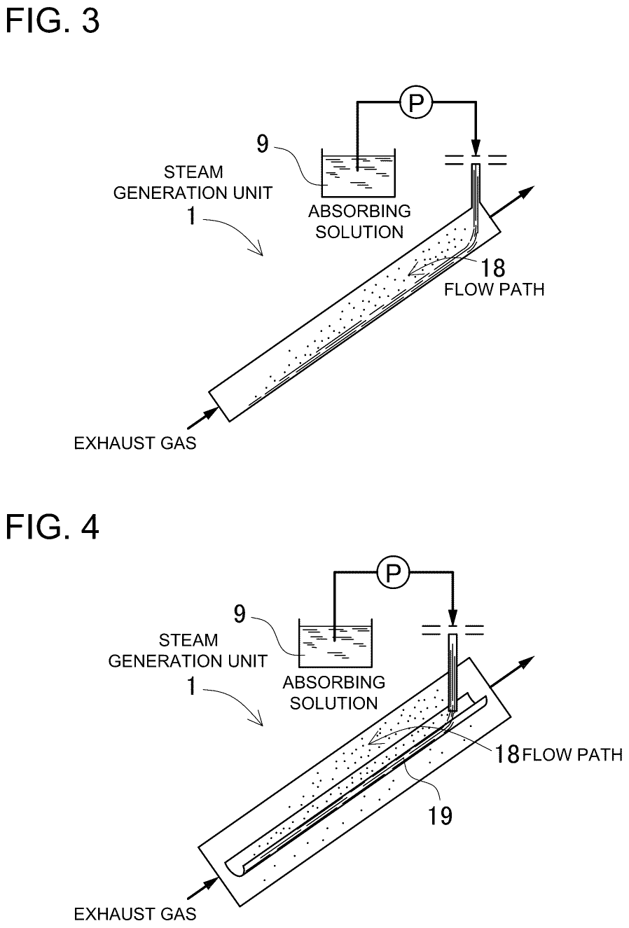

As shown in FIG. 3, a steam generation unit 1 that vaporizes absorbing solution 9 via the thermal energy of the exhaust gas can also incorporate a descending inclined flow path 18 exposed to the exhaust gas and into which absorbing solution 9 is supplied and heated by the exhaust gas for vaporization. Additionally, as shown in FIG. 4, a heater 19, which is heated by exhaust gas thermal energy, can also be installed in the exhaust gas flow path 18 to vaporize absorbing solution supplied to the heater 19. The heater 19 in FIG. 4 is a gutter pipe on a descending incline, and absorbing solution 9 supplied to the upper end of the gutter pipe flows naturally downward to vaporize the absorbing solution 9 via exhaust gas thermal energy.

The steam generation unit 1 in FIG. 1 heats and vaporizes the absorbing solution 9 using waste heat from an industrial plant, and specifically this steam generation unit 1 vaporizes absorbing solution 9 with waste heat from the steam turbine 22 of a power plant 20. More specifically, the steam generation unit 1 uses thermal energy from a condenser 23, which cools and liquefies steam discharged from the steam turbine 22 that drives a generator 21 in the power plant 20. Since this steam generation unit 1 utilizes waste heat from the condenser 23 to vaporize absorbing solution 9, it can reduce the energy cost for absorbing solution 9 vaporization. Steam discharged from the steam turbine 22 incorporates a significant amount of thermal energy and plant operation requires its liquefaction. The condenser 23 liquefies steam emitted from the steam turbine 22 for circulation back to the boiler 24. Water liquefied in the condenser 23 is heated in the boiler 24 and circulated to the steam turbine 22. Since the temperature of steam supplied from the steam turbine 22 to the condenser 23 exceeds 100° C., the steam generation unit 1 can effectively heat and vaporize absorbing solution 9. The latent heat released during the condensation of turbine steam is substantial, and enables efficient vaporization of the absorbing solution 9.

The power plant 20 uses seawater to cool the condenser 23. Consequently, heat released by the condenser 23 contributes to an increase in seawater temperature. An apparatus that uses thermal energy absorbed by the condenser 23 to vaporize absorbing solution 9 can reduce the amount of heat released into the seawater by the condenser 23. This mitigates seawater temperature rise and contributes to environmental preservation.

The condenser 23 shown in FIG. 1 is provided with a seawater heat exchanger 25 and an absorbing solution heat exchanger 26. The seawater heat exchanger 25 circulates seawater to cool and liquefy steam emitted from the steam turbine 22, while the absorbing solution heat exchanger 26 heats and vaporizes the absorbing solution 9 that passes through it. Since the condenser 23 cools and liquefies steam supplied from the steam turbine 22 via both the absorbing solution heat exchanger 26 and the seawater heat exchanger 25, the system can control the amount of heat energy used for vaporizing the absorbing solution 9 and the amount of heat energy absorbed by the seawater heat exchanger 25. This configuration allows steam supplied from the steam turbine 22 to be liquefied and circulated back to the boiler 24 while vaporizing the absorbing solution 9.

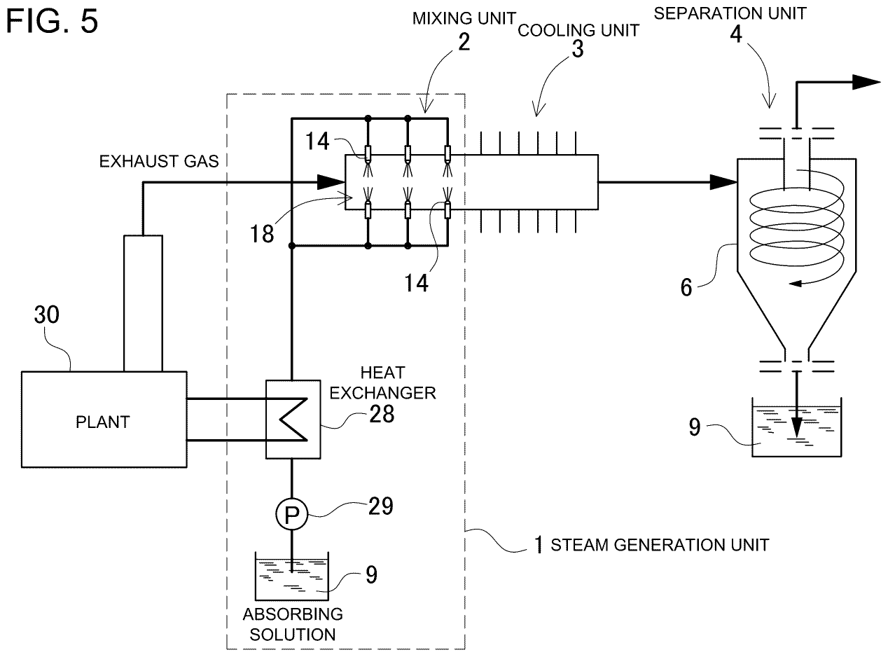

In addition to power plants, industrial facilities such as cement factories and smelting furnaces, which burn coal, oil, or gas as fuel, often release heat with a temperature less than or equal to 200° C. into the atmosphere without effective utilization. In particular, exhaust heat in a temperature range of 100-200° C. is typically vented without efficient use. Industrial facilities that emit exhaust gases can utilize their unused heat to heat and vaporize absorbing solution. The steam generation unit 1 shown in FIG. 5 is provided with a heat exchanger 28 that heats and vaporizes absorbing solution 9 using waste heat from an industrial plant 30. The heat exchanger 28 heats and vaporizes absorbing solution 9 that is delivered by a pump 29, and the resulting vapor is supplied to the mixing unit 2. This steam generation unit 1 significantly reduces the thermal energy required to generate absorbing solution vapor, and thereby reduces operating cost.

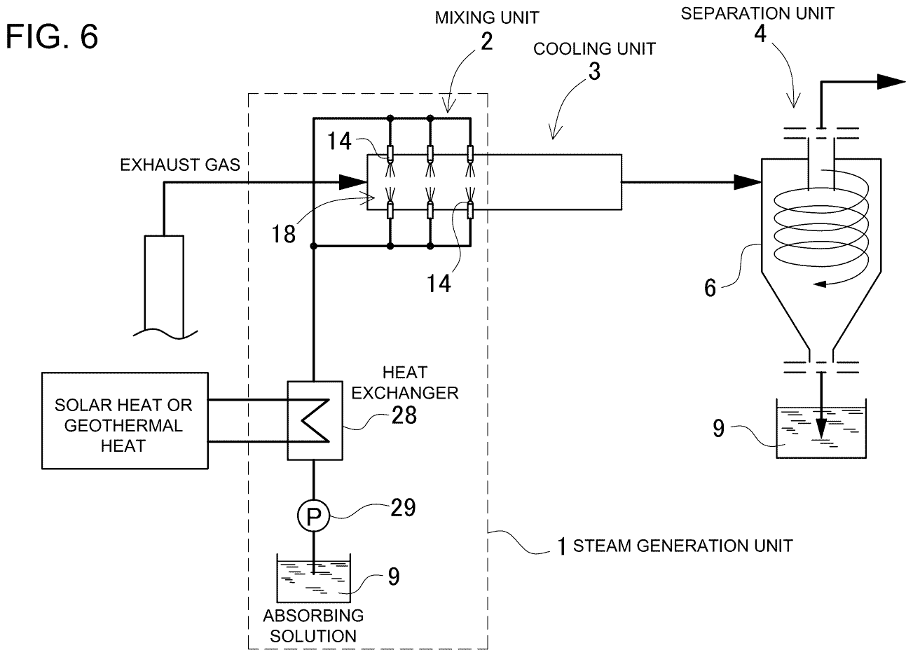

While the steam generation unit 1 shown in FIG. 1 can efficiently vaporize absorbing solution 9 using waste heat from the steam turbine 22 of a power plant 20, other facilities such as smelting furnaces, cement factories, and chemical plants can heat and vaporize the absorbing solution 9 using waste heat from the plant 30 as shown in FIG. 5. In a cement factory, absorbing solution can be heated by exhaust heat from a cement kiln. Alternatively, as shown in FIG. 6, absorbing solution 9 can be heated and vaporized using solar or geothermal energy.

### Mixing Unit 2

The mixing unit 2 can employ any mechanism that mixes absorbing solution vapor supplied from the steam generation unit 1 with exhaust gas to produce vapor-containing exhaust gas. The mixing unit 2 can serve solely as a mechanism for mixing exhaust gas and absorbing solution vapor or can be integrated with the steam generation unit. Although the present invention does not specifically stipulate the structure of the mixing unit 2, mixing unit 2 examples include static mixers or mixing devices that spray absorbing solution vapor to stir the exhaust gas.

As shown in FIGS. 2 and 5, the mixing unit 2 can be integrated as part of the steam generation unit 1. In FIG. 2, the steam generation unit 1 injects liquid absorbing solution 9 through the nozzles 14 into exhaust gas that has a temperature greater than or equal to 100° C. Accordingly, the liquid absorbing solution 9 is vaporized by the thermal energy of the exhaust gas and the resulting vapor is dispersed into the exhaust gas. Since the vaporized absorbing solution 9 mixes with the exhaust gas, this mixing unit 2 is integrated into the steam generation unit 1. Similarly, in FIG. 5, the steam generation unit 1 injects pressurized liquid absorbing solution 9 heated in the liquid state to a temperature greater than or equal to 100° C. into the exhaust gas through nozzles 14. While liquid at 1 atmosphere of pressure boils and vaporizes at 100° C., the boiling point of pressurized liquid increases above that temperature. For example, pressurizing the absorbing solution 9 to approximately 4.7 atmospheres raises its boiling point to 150° C., and at approximately 10 atmospheres, the boiling point reaches 180° C. By heating the liquid absorbing solution 9 to 150-180° C. and injecting it under pressure into the exhaust gas, post-injection pressure drop causes the liquid to vaporize and disperse into the exhaust gas. Since the steam generation units 1 in both FIG. 2 and FIG. 5 disperse absorbing solution vapor into the exhaust gas, the mixing unit 2 is integrated as a single structure. Similarly, since the steam generation units 1 in FIGS. 3 and 4 supply absorbing solution 9 into exhaust gas for vaporization these configurations also allow the steam generation unit 1 and mixing unit 2 to be integrated as a single structure. Alternatively, as shown in FIG. 1, a dedicated mixing unit 2 can be provided to achieve a more uniform mixture of exhaust gas and absorbing solution vapor.

### Cooling Unit 3

The cooling unit 3 can be any mechanism capable of cooling and liquefying absorbing solution vapor in the exhaust gas. The cooling unit 3 condenses absorbing solution vapor by cooling vapor-containing exhaust gas, which is absorbing solution vapor mixed with exhaust gas. Any structure that can cool the vapor-containing exhaust gas to liquefy the absorbing solution vapor can be used as the cooling unit 3. The cooling unit 3 can be integrated with the mixing unit 2. The cooling unit 3 shown in FIG. 6 is integrated with the mixing unit 2 and it liquefies absorbing solution vapor by cooling vapor-containing exhaust gas with exhaust gas having a temperature of 100° C. or lower. In FIG. 6, the mixing unit heats liquid absorbing solution to above 100° C. for vaporization, but it cools and liquefies the absorbing solution vapor using exhaust gas at 100° C. or lower. Accordingly, the discharge side of the mixing unit 2 functions as the cooling unit 3 that liquefies absorbing solution vapor without requiring a dedicated cooling unit. Vaporization of absorbing solution into the exhaust gas can cool the exhaust gas due to the latent heat of vaporization. Therefore, a treatment apparatus that supplies steam mist to exhaust gas can cool the exhaust gas via the latent heat of vaporization of the mist component of the steam mist, and the cooled exhaust gas can be used to cool and liquefy absorbing solution vapor. Accordingly, while the treatment apparatus in FIG. 2 includes a dedicated cooling unit 3, the treatment apparatus can liquefy the supplied absorbing solution vapor with a cooling unit that is integrated as a single structure with the mixing unit without providing a dedicated cooling unit.

Absorbing solution vapor is cooled and condensed in the cooling unit 3, and during this process water-soluble gases are efficiently absorbed. This is because extremely fine absorbing solution vapor particles are efficiently condensed and liquefied. Vaporization of one mole (18 g) of absorbing solution water creates 6×10²³ micro-particles. Since these absorbing solution vapor micro-particles are condensed and liquefied, water-soluble gases are efficiently absorbed by an enormous number of vapor particles during that condensing and liquefying process. Absorbing solution 9 that has condensed and become liquid disperses as mist in the exhaust gas or adheres to cooling surfaces as moisture condensation. The cooling unit 3 cools the vapor-containing exhaust gas below its dew point and causes supersaturated absorbing solution vapor to liquefy. The saturated vapor capacity of vapor-containing exhaust gas varies with temperature. Saturation vapor capacity decreases as the temperature of the vapor-containing exhaust gas decreases. Therefore, the lower the temperature to which the cooling unit 3 cools the vapor-containing exhaust gas, the greater the amount of absorbing solution vapor that is liquefied.

As noted above, the amount of moisture that vapor-containing exhaust gas can retain in its gaseous state, namely its saturation vapor capacity, varies with temperature. As the temperature of the vapor-containing exhaust gas decreases, its saturation vapor capacity also decreases. When vapor-containing exhaust gas is cooled, saturation vapor capacity is lowered, and supersaturated moisture is liquefied. For example, the saturation vapor capacity of vapor-containing exhaust gas decreases from 292 g/m³ at 80° C. to 30 g/m³ at 30° C., 17 g/m³ at 20° C., and 13 g/m³ at 15° C. Therefore, cooling 1 m³ of vapor-containing exhaust gas at 80° C. (and 100% relative humidity) to 20° C. in a cooling unit 3 can liquefy 175 g of vapor (292 g/m³-17 g/m³). Since liquefaction of absorbing solution vapor separates water-soluble gases from the exhaust gas, water-soluble gases can be efficiently separated by increasing the amount of absorbing solution 9 liquefied.

The cooling unit 3 can increase the amount of absorbing solution 9 liquefied by maximizing the temperature differential of the vapor-containing exhaust gas before and after cooling. The cooling unit 3 is designed to cool vapor-containing exhaust gas with a temperature differential that is, for example, greater than or equal to 30° C., preferably greater than or equal to 35° C., and more preferably greater than or equal to 40° C. Since the cooling unit 3 can increase the temperature differential by lowering the cooling temperature, the post-cooling temperature of the vapor-containing exhaust gas can be made, for example, less than or equal to 30° C. (saturation vapor capacity 30 g/m³), preferably less than or equal to 20° C. (saturation vapor capacity 17 g/m³), and more preferably less than or equal to 15° C. (saturation vapor capacity 13 g/m³).

Vapor-containing exhaust gas with a relative humidity of less than 100% can be cooled below its dew point to liquefy supersaturated absorbing solution vapor. For example, vapor-containing exhaust gas at 80° C. and 80% relative humidity contains 234 g of water vapor per cubic meter. When cooled to 30° C., where the saturation vapor capacity drops to 30 g/m³, 204 g (234 g-30 g) of absorbing solution vapor is liquefied. Accordingly, the cooling unit 3 can liquefy absorbing solution vapor by cooling vapor-containing exhaust gas with a relative humidity of less than 100% below its dew point. However, vapor-containing exhaust gas at 80° C. and 80% relative humidity does not liquefy absorbing solution vapor when cooled to 75° C. This is because the saturation vapor capacity of vapor-containing exhaust gas at 75° C. is 240 g/m³, which is higher than the saturation vapor capacity at 80° C. and 80% relative humidity (234 g/m³), and absorbing solution vapor cannot attain a supersaturated state. Consequently, the cooling unit 3 can liquefy absorbing solution vapor in vapor-containing exhaust gas that has a relative humidity below 100% by cooling the vapor-containing exhaust gas to a temperature lower than its dew point.

### Separation Unit 4

The separation unit 4 can be any mechanism capable of recovering absorbing solution 9 liquefied in the cooling unit 3 from the exhaust gas. The separation unit 4 recovers liquefied absorbing solution 9 from the exhaust gas. By separating the liquefied absorbing solution 9, the separation unit 4 separates water-soluble gases from the exhaust gas. Since the absorbing solution 9 dissolves water-soluble gases and becomes liquefied, recovering the liquefied absorbing solution 9 allows of various water-soluble gases such as carbon dioxide, NOₓ, SOₓ, and ammonia gas to be separated from the exhaust gas.

Liquefied absorbing solution 9 forms fine water droplets in the exhaust gas, (i.e. disperses as mist in the exhaust gas), or condenses on cooling surfaces used to cool the vapor-containing exhaust gas. Absorbing solution 9 mist dispersed in the exhaust gas can be separated and recovered using a gas-liquid separator such as a cyclone separator. A cyclone gas-liquid separator 6 can recover absorbing solution 9 mist from the exhaust gas with a simple structure.

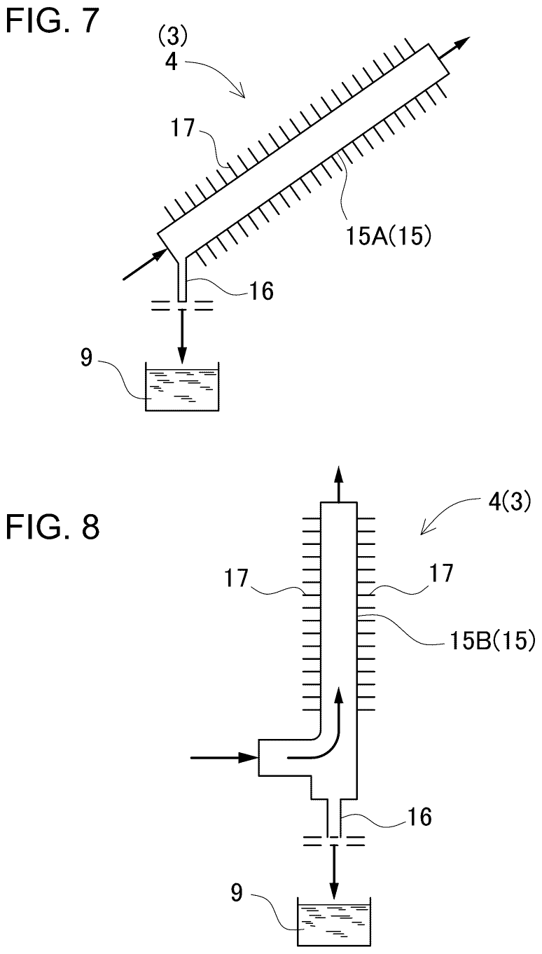

The separation unit 4 can also recover the absorbing solution 9 from cooling surfaces where absorbing solution 9 condenses. In FIGS. 7 and 8, the separation unit 4 is integrated with the cooling unit 3. An exhaust gas duct 15 is provided with a trap 16 to discharge liquefied absorbing solution 9 to the outside. In FIG. 7, the exhaust gas duct 15A slopes downward opposite the direction of exhaust gas flow, while the duct 15B in FIG. 8 has a vertical orientation that allows the condensed absorbing solution 9 to flow downward and be discharged through the trap 16. In these separation units 4, the duct 15 is cooled to condense absorbing solution 9 on the inner surface, and the absorbing solution 9 condensate flows downward to the trap 16 for recovery. The ducts 15A and 15B in FIGS. 7 and 8 are provided with heat dissipation fins 17 on their outer surfaces to cool the ducts. Exhaust gas ducts cooled by the heat dissipation fins 17 have a simple structure and allow cooling with ambient air at room temperature. Although not illustrated, an exhaust gas duct can also be provided with cooling plates that protrude inward to the interior of the duct, and surfaces of the cooling plates serve as cooling surfaces. This design increases the surface area in contact with the exhaust gas to improve absorbing solution vapor condensing efficiency. In addition, an exhaust gas duct can be forcibly cooled by thermal coupling with heat exchanger pipes through which cooling fluid circulates. The separation units 4 described here are integrated with the cooling units 3 to efficiently cool and recover liquefied absorbing solution 9 from vapor-containing exhaust gas with a simple structure.

The block diagram in FIG. 1 illustrates an example of an apparatus that recovers water-soluble carbon dioxide gas from the exhaust gas of a power plant 20. However, the exhaust gas treatment apparatus of the present invention is not limited to apparatus used in power plants.

Exhaust gases discharged from various plants are primarily generated by burning fuels such as coal, oil, gas, and wood. Exhaust gas contains components such as carbon dioxide, NOₓ, and SOₓ. The treatment apparatus 100 in the block diagram of FIG. 1 is capable of separating carbon dioxide, NOₓ, SOₓ, and other water-soluble gases. The treatment apparatus of the present invention is not only capable of separating water-soluble gases from gas generated by combustion, but can also separate water-soluble gases from any carrier gas that contains water-soluble gases. For example, when the exhaust gas is air containing ammonia gas, it can be treated to separate and recover ammonia gas, and the recovered ammonia can be reused.

The exhaust gas treatment apparatus of the present invention can be used to efficiently separate water-soluble gases such as carbon dioxide from exhaust gas.

### REFERENCE SIGNS LIST

100 exhaust gas treatment apparatus
1 steam generation unit
2 mixing unit
3 cooling unit
4 separation unit
5 pre-treatment unit
6 gas-liquid separator
9 absorbing solution
10 condensed solution
11 exhaust gas heat exchanger
12 gas-liquid separator
13 heat dissipation fin
14 nozzle
15, 15A, 15B duct
16 trap
17 heat dissipation fin
18 flow path
19 heater
20 power plant
21 generator
22 steam turbine
23 condenser
24 boiler
25 seawater heat exchanger
26 absorbing solution heat exchanger
28 heat exchanger
29 pump
30 plant

1. An exhaust gas treatment apparatus comprising:
a steam generation unit that heats an absorbing solution to generate absorbing solution vapor;
a mixing unit that mixes the vapor generated in the steam generation unit with exhaust gas;
a cooling unit that cools the absorbing solution vapor to absorb and liquefy water-soluble gases in the exhaust gas; and
a separation unit that separates the liquefied absorbing solution from the exhaust gas.

2. The exhaust gas treatment apparatus as cited in claim 1, wherein the steam generation unit generates a steam mist that contains both absorbing solution vapor and mist, and the mixing unit mixes the steam mist with the exhaust gas.

3. The exhaust gas treatment apparatus as cited in claim 1, wherein the steam generation unit generates superheated steam of the absorbing solution.

4. The exhaust gas treatment apparatus as cited in claim 1, wherein the steam generation unit generates vapor of an absorbing solution in which a solute that chemically bonds with water-soluble gas is dissolved.

5. The exhaust gas treatment apparatus as cited in claim 1, wherein the steam generation unit generates vapor of an absorbing solution that is water, seawater, alkaline water, acidic water, an aqueous solution of calcium hydroxide, or an aqueous solution of sodium hydroxide.

6. The exhaust gas treatment apparatus as cited in claim 1, wherein the steam generation unit vaporizes the absorbing solution using waste heat from the plant that discharges the exhaust gas.

7. The exhaust gas treatment apparatus as cited in claim 6, wherein the exhaust gas is exhaust gas discharged from a power plant, and the steam generation unit heats the absorbing solution using waste heat resulting from power generation in the power plant.

8. The exhaust gas treatment apparatus as cited in claim 7, wherein the steam generation unit heats the absorbing solution using waste heat from a steam turbine that drives a generator in the power plant.

9. The exhaust gas treatment apparatus as cited in claim 6, wherein the exhaust gas is exhaust gas discharged from a blast furnace, and the steam generation unit heats and vaporizes the absorbing solution using waste heat from the blast furnace.

10. The exhaust gas treatment apparatus as cited in claim 6, wherein the exhaust gas is exhaust gas discharged from a cement factory, and the steam generation unit heats and vaporizes the absorbing solution using waste heat from a cement kiln

11. The exhaust gas treatment apparatus as cited in claim 6, wherein the exhaust gas is exhaust gas discharged from a chemical plant, and the steam generation unit heats and vaporizes the absorbing solution using waste heat from the chemical plant.

12. The exhaust gas treatment apparatus as cited in claim 1, wherein the steam generation unit heats and vaporizes the absorbing solution using solar heat or geothermal heat.

13. The exhaust gas treatment apparatus as cited in claim 1, wherein the cooling unit cools vapor-containing exhaust gas, which is absorbing solution vapor mixed with exhaust gas, to cool the vaporized absorbing solution.

14. The exhaust gas treatment apparatus as cited in claim 13, wherein the temperature of the vapor-containing exhaust gas before cooling by the cooling unit is greater than or equal to 50° C.

15. The exhaust gas treatment apparatus as cited in claim 14, wherein the cooling temperature differential of the cooling unit is greater than or equal to 30° C.

16. The exhaust gas treatment apparatus as cited in claim 1, wherein the cooling unit mixes absorbing solution vapor with exhaust gas to cool the absorbing solution vapor with the exhaust gas.

17. The exhaust gas treatment apparatus as cited in claim 1, further comprising a pre-treatment unit that cools the exhaust gas to separate a condensed solution, and wherein the mixing unit mixes absorbing solution vapor with exhaust gas that has condensed solution removed by the pre-treatment unit.

18. The exhaust gas treatment apparatus as cited in claim 17, wherein the pre-treatment unit separates condensed solution generated by cooling the exhaust gas to separate NOₓ and SOₓ from the exhaust gas.

19. The exhaust gas treatment apparatus as cited in claim 1, wherein the water-soluble gas includes carbon dioxide, NOₓ, SOₓ, ammonia gas, alcohol, ester, or toluene.
